(19) United States
(12) Patent Application Publication
(10) Pub. No.: US 2025/0090943 A1
(43) Pub. Date: Mar. 20, 2025

(54) CONTROL DEVICE FOR CONTROLLING AN INFORMATION PROCESSING DEVICE, A METHOD, A SYSTEM AND A COMPUTER PROGRAM

(71) Applicant: Sony Interactive Entertainment Inc., Tokyo (JP)

(72) Inventors: Mark Jacobus Breugelmans, London (GB); Michael Eder, London (GB); Hogarth Andall, London (GB); Jun Yen Leung, London (GB)

(73) Assignee: Sony Interactive Entertainment Inc., Tokyo (JP)

(21) Appl. No.: 18/825,119

(22) Filed: Sep. 5, 2024

(30) Foreign Application Priority Data
Sep. 14, 2023 (GB) 2314025.4

(51) Int. Cl. A63F 13/22; A63F 13/285

(52) U.S. Cl. CPC A63F 13/22; A63F 13/285

(57) ABSTRACT

A control device for controlling an information processing device is provided, the control device comprising: a plurality of input units configured to be operated by a user; a generating unit configured to generate an input signal when at least one of the plurality of input units is operated by the user; an adjustment unit configured to adjust at least one of the plurality of input units; and a control unit configured to control the adjustment unit to restrict operation of the at least one of the input units in accordance with adjustment information indicating an availability of each of the plurality of input units for controlling the information processing device.

### BACKGROUND

### Field of the Disclosure

The present disclosure relates to a control device for controlling an information processing device, a method, a system and a computer program product for the same.

### Description of the Related Art

The “background” description provided herein is for the purpose of generally presenting the context of the disclosure. Work of the presently named inventors, to the extent it is described in the background section, as well as aspects of the description which may not otherwise qualify as prior art at the time of filing, are neither expressly or impliedly admitted as prior art against the present invention.

An information processing device may be configured to execute software. This software may include software such as a video game or the like. The output from the software executed on the information processing device may be presented to a user on a display device or the like. In this way, a user can enjoy playing a video game (or other software) on the information processing device.

However, a user often has to operate a control device to control an information processing device. For example, the user may need to operate a control device to control the information processing device to play the video game (or other software) on the information processing device. It can be difficult for a user to use a control device to control an information processing device when they are not familiar with the information processing device or the software operating on the information processing device. For example, a user playing a video game on the information processing device may perform erroneous operations with the control device if they are unaware of the appropriate control operations which can be performed to play the video game.

This problem is often exacerbated when a same or similar control device is used to control different types of information processing device and/or different software operating on a same information processing device. Furthermore, this problem may also be exacerbated for a novice or inexperienced user.

It is an aim of the present disclosure to address or mitigate this problem.

### SUMMARY

A brief summary about the present disclosure is provided hereinafter to provide basic understanding related to certain aspects of the present disclosure.

Embodiments of the present disclosure are defined by the independent claims. Further aspects of the disclosure are defined by the dependent claims.

In accordance with embodiments of the disclosure, dynamic adjustment of the control device can be performed in order to tailor the control device for a specific use. This may facilitate the use of the control device when training a user for operation of an information processing device, as a user can learn which operations can be performed. Furthermore, the impact and effect of erroneous operations can be supressed.

The present disclosure is not particularly limited to these advantageous technical effects. Other technical effects will become apparent for the skilled person when reading the disclosure.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates an apparatus in accordance with embodiments of the disclosure;

FIG. 2 illustrates an example of an entertainment system in accordance with embodiments of the disclosure;

FIG. 3 illustrates an example handheld controller in accordance with embodiments of the disclosure;

FIG. 4 illustrates the architecture of an example HMD device in accordance with embodiments of the disclosure;

FIG. 5 illustrates an example control device in accordance with embodiments of the disclosure;

FIG. 6 illustrates an example system in accordance with embodiments of the disclosure;

FIGS. 7A and 7B illustrates an example adjustment of an input unit in accordance with embodiments of the disclosure;

FIG. 8 illustrates an example control device in accordance with embodiments of the disclosure;

FIG. 9 illustrates an example method in accordance with embodiments of the disclosure.

### DESCRIPTION OF THE EMBODIMENTS

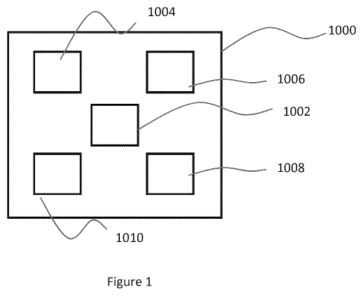

Referring to FIG. 1, an apparatus 1000 (an example of an information processing device) according to embodiments of the disclosure is shown. Typically, an apparatus 1000 according to embodiments of the disclosure is a computer device such as a personal computer, an entertainment system or video game console, or a terminal connected to a server. Indeed, in embodiments, the apparatus may also be a server. The apparatus 1000 is controlled using a microprocessor or other processing circuitry 1002. In some examples, the apparatus 1000 may be a portable computing device such as a mobile phone, laptop computer or tablet-computing device.

The processing circuitry 1002 may be a microprocessor carrying out computer instructions or may be an Application Specific Integrated Circuit. The computer instructions are stored on storage medium 1004 which maybe a magnetically readable medium, optically readable medium or solid state type circuitry. The storage medium 1004 may be integrated into the apparatus 1000 or may be separate to the apparatus 1000 and connected thereto using either a wired or wireless connection. The computer instructions may be embodied as computer software that contains computer readable code which, when loaded onto the processor circuitry 1002, configures the processor circuitry 1002 to perform a method according to embodiments of the disclosure.

Additionally, an optional user input device 1006 is shown connected to the processing circuitry 1002. The user input device 1006 may be a touch screen or may be a mouse or stylist type input device. The user input device 1006 may also be a keyboard, controller, or any combination of these devices. In some examples, the user input device 1006 may be a microphone or other device. The user to may then provide input via sounds or speech.

A network connection 1008 may optionally be coupled to the processor circuitry 1002. The network connection 1008 may be a connection to a Local Area Network or a Wide Area Network such as the Internet or a Virtual Private Network or the like. The network connection 1008 may be connected to a server allowing the processor circuitry 1002 to communicate with another apparatus in order to obtain or provide relevant data. The network connection 1002 may be behind a firewall or some other form of network security.

Additionally, shown coupled to the processing circuitry 1002, is a display device 1010. The display device 1010, although shown integrated into the apparatus 1000, may additionally be separate to the apparatus 1000 and may be a monitor or some kind of device allowing the user to visualize the operation of the system (e.g. a display screen or a head mounted display). In addition, the display device 1010 may be a printer, projector or some other device allowing relevant information generated by the apparatus 1000 to be viewed by the user or by a third party.

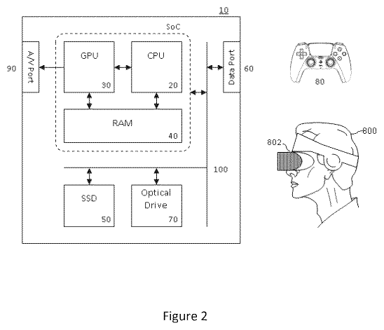

Referring now to FIG. 2, an example of an entertainment system in accordance with embodiments of the disclosure is illustrated. The entertainment system 10 is an example of an information processing device in accordance with embodiments of the disclosure.

The entertainment system 10 comprises a central processor 20. This may be a single or multi core processor. The entertainment system also comprises a graphical processing unit or GPU 30. The GPU can be physically separate to the CPU, or integrated with the CPU as a system on a chip (SoC).

The entertainment device also comprises RAM 40, and may either have separate RAM for each of the CPU and GPU, or shared RAM. The or each RAM can be physically separate, or integrated as part of an SoC. Further storage is provided by a disk 50, either as an external or internal hard drive, or as an external solid state drive, or an internal solid state drive.

The entertainment device may transmit or receive data via one or more data ports 60, such as a USB port, Ethernet® port, WiFi® port, Bluetooth® port or similar, as appropriate. It may also optionally receive data via an optical drive 70.

Interaction with the system is typically provided using one or more handheld controllers 80.

Audio/visual outputs from the entertainment device are typically provided through one or more A/V ports 90, or through one or more of the wired or wireless data ports 60.

Where components are not integrated, they may be connected as appropriate either by a dedicated data link or via a bus 100.

An example of a device for displaying images output by the entertainment system is a head mounted display ‘HMD’ 802, worn by a user 800.

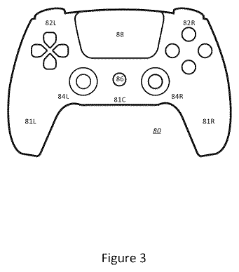

Turning now to FIG. 3 of the present disclosure, an example of a handheld controller in accordance with embodiments of the disclosure is illustrated. The handheld controller is a type of control device which can be used for controlling an information processing device. The handheld controller may be used to control the entertainment system 10 of FIG. 2, for example.

Indeed, in FIG. 3, a controller 80 is illustrated as a specific example of a handheld controller. Such a controller typically has two handle sections 81L,R and a central body 81C. Various controls are distributed over the controller, typically in local groups. Examples include a left button group 82L, which may comprise directional controls and/or one or more shoulder buttons, and similarly right button group 82R, which comprise function controls and/or one or more shoulder buttons. The controller also includes left and/or right joysticks 84L,R, which may optionally also be operable as buttons by pressing down on them.

The controller (typically in the central portion of the device) may also comprise one or more system buttons 86, which typically cause interaction with an operating system of the entertainment device rather than with a game or other application currently running on it; such buttons may summon a system menu, or allow for recording or sharing of displayed content. Furthermore, the controller may comprise one or more other elements such as a touchpad 88, a light for optical tracking (not shown), a screen (not shown), haptic feedback elements (not shown), and the like.

It will be appreciated that a head mounted display ‘HMD’, worn by a user, can display images output by the entertainment system.

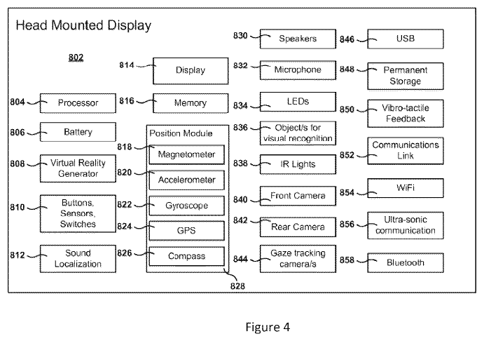

Referring now to FIG. 4, this illustrates the architecture of an example HMD device. The HMD may also be a computing device and may include modules usually found on a computing device, such as one or more of a processor 804, memory 816 (RAM, ROM, etc.), one or more batteries 806 or other power sources, and permanent storage 848 (such as a solid state disk). The HMD device is an example of a type of control device which can be used for controlling an information processing system (such as the entertainment system of FIG. 2 of the present disclosure).

One or more communication modules can allow the HMD to exchange information with other portable devices, other computers, other HMDs, servers, etc. Communication modules can include a Universal Serial Bus (USB) connector 846, a communications link 852 (such as Ethernet®), ultrasonic or infrared communication 856, Bluetooth® 858, and WiFi® 854.

A user interface can include one or more modules for input and output. The input modules can include input buttons (e.g. a power button), sensors and switches 810, a microphone 832, a touch sensitive screen (not shown, that may be used to configure or initialize the HMD), one or more front cameras 840, one or more rear cameras 842, one or more gaze tracking cameras 844. Other input/output devices, such as a keyboard or a mouse, can also be connected to the portable device via communications link, such as USB or Bluetooth®. Therefore, a user can provide input using these input devices in order to control an information processing device.

The output modules can include the display 814 for rendering images in front of the user's eyes. Some embodiments may include one display, two displays (one for each eye), micro projectors, or other display technologies. Other output modules can include Light-Emitting Diodes (LED) 834 (which may also be used for visual tracking of the HMD), vibro-tactile feedback 850, speakers 830, and a sound localization module 812, which performs sound localization for sounds to be delivered to speakers or headphones. Other output devices, such as headphones, can also connect to the HMD via the communication modules, be permanently attached to the HMD, or integral to it.

One or more elements that may be included to facilitate motion tracking include LEDs 834, one or more objects for visual recognition 836, and infrared lights 838. Alternatively or in addition, the one or more front or rear cameras may facilitate motion tracking based on image motion.

Information from one or more different modules can be used by the position module 828 to calculate the position of the HMD. These modules can include a magnetometer 818, an accelerometer 820, a gyroscope 822, a Global Positioning System (GPS) module 824, and a compass 826. Alternatively or in addition, the position module can analyze image data captured with one or more of the cameras to calculate the position. Further yet, optionally the position module can perform tests to determine the position of the portable device or the position of other devices in the vicinity, such as a WiFi ping test or ultrasound tests.

A virtual reality generator 808 then outputs one or more images corresponding to a virtual or augmented reality environment or elements thereof, using the position calculated by the position module. The virtual reality generator 808 may cooperate with other computing devices (e.g., game console, Internet server, etc.) to generate images for the display module 814. The remote devices may send screen updates or instructions for creating game objects on the screen. Hence the virtual reality generator 808 may be responsible for none, some, or all of the generation of one or more images then presented to the user, and/or may be responsible for any shifting of some or all of one or both images in response to inter-frame motion of the user (e.g. so-called reprojection).

It should be appreciated that the embodiment illustrated in FIG. 4 is an exemplary implementation of an HMD, and other embodiments may utilize different modules, a subset of the modules, or assign related tasks to different modules. The embodiment illustrated in FIG. 4 should therefore not be interpreted to be exclusive or limiting, but rather exemplary or illustrative. It will also be appreciated that the functionality of at least a subset of the modules may be provided by, or in concert with, corresponding modules of the entertainment device (in turn typically provided by a processor of that device operating under suitable software instruction).

An information processing device (such as an entertainment system 10 as described with reference to FIG. 2 of the present disclosure) may be configured to execute software. This software may include software such as a video game or the like. The output from the software executed on the information processing device may be presented to a user on a display device or the like. In this way, a user can enjoy playing a video game (or other software) on the information processing device.

However, a user often has to use a control device to control an information processing device. For example, the user may need to use a control device to control the information processing device to play the video game (or other software) on the information processing device. It can be difficult for a user to use a control device to control an information processing device when they are not familiar with the information processing device or the software operating on the information processing device. For example, a user playing a video game on the information processing device may perform erroneous operations with the control device if they are unaware of the appropriate control operations which can be performed to play the video game.

Consider, for example, a situation where a user is playing a video game on an entertainment system 10 using a controller (or control device) such as the handheld controller 80 described with reference to FIG. 3 of the present disclosure. The user may perform erroneous operation of the handheld controller 80. For example, the user may press a button or set of buttons on the controller which are not appropriate for the current video game being played. This may include a button or set of buttons on the handheld controller 80 which do not have an associated action in the video game (or the current stage of the video game being played). If no action is performed in the video game in response to the erroneous operation of the control device, the frustration of the user may increase. Indeed, the user may repeatedly try to press a button on the controller (thus repeating the erroneous operation) if they do not understand that the button is not appropriate for the current video game being played. This may cause a delay in the user being able to perform a correct input operation using the control device.

This problem is often exacerbated when a same or similar control device is used to control different types of information processing device and/or different software operating on a same information processing device.

For example, a button or set of buttons on a controller may be appropriate for a first video game (or a first stage of a video game) but may not be appropriate for a second, different, video game (or a second, different, stage of a video game). Therefore, a user may not understand that a certain operation is not available or may easily become confused when using a same control device in different situations.

Furthermore, this problem may also be exacerbated for a novice or inexperienced user. That is, a novice or inexperienced user may not yet understand which operations can be performed using a control device for a certain situation. Therefore, the novice or inexperienced user may perform an even greater number of erroneous operations.

As such, for at least these reasons (in addition to the reasons explained in the Background) a control device for controlling an information processing device, a method, a system and a computer program are provided in accordance with embodiments of the disclosure.

### <Control Device>

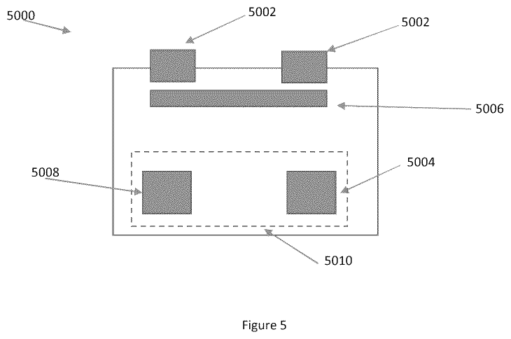

Embodiments of the disclosure provide a control device for controlling an information processing device. FIG. 5 illustrates an example control device for controlling an information processing device.

The control device 5000 illustrated in FIG. 5 of the present disclosure comprises a plurality of input units 5002. The plurality of input units are configured to be operated by a user. This enables the user to provide an input, using the control device, to control an information processing device. In examples, the plurality of input units (or input devices) may include one or more of a list including: a button, a trigger, a joystick, a joystick button, a touchpad, a touchpad button, a wheel and/or a pedal. However, the present disclosure is not particularly limited in this respect and any type of input unit may be used.

FIG. 5 illustrates an example where two input units 5002 are provided. However, the present disclosure is not particularly limited in this regard. In examples, the number of input units provided on the control device 5000 may different that this example. That is, many more input units may be provided on the control device 5000. As such, the control device 5000 is not particularly limited to the example configuration illustrated with respect to FIG. 5 of the present disclosure.

The control device 5000 further comprises a generating unit 5004. The generating unit 5004 is configured to generate an input signal when at least one of the plurality of input units is operated by the user. Thus, when a user operates an input unit 5002 of the control device, the generating unit 5004 is configured to generate a corresponding input signal which indicates that the input unit 5002 has been operated. The input signal generated by the generating unit 5004 can then be used for control of an information processing device. For example, the generating unit may be configured to transmit the input signal to the information processing device. The information processing device may then perform an action in response to the input which has been provided by the user.

The way in which the generating unit 5004 generates the input signal upon operation of the input unit 5002 is not particularly limited. Indeed, the way in which the generating unit 5004 generates the input signal will vary depending upon the type of the input device which has been operated. As an example, when the input unit 5002 is a button, the generating unit 5004 may detect a change in voltage and generate an input signal indicating that the button has been pressed. Alternatively, when the input unit 5002 is a touch pad, the generating unit 5004 may detect a change in capacitance and generate an input signal indicating that the touch pad has been operated by the user. However, these are only examples of different ways in which the generating unit 5004 may generate the input signal upon operation of the input unit 5002 and the present disclosure is not particularly limited in this respect.

In the example of FIG. 5 of the present disclosure, the generating unit 5004 is shown separate from the plurality of input units 5002. However, in other examples, a dedicated generating unit 5004 may be provided with (or as part of) the input units 5002. Therefore, the control device 5000 is not particularly limited to the example configuration illustrated with reference to FIG. 5 of the present disclosure.

The control device 5000 further comprises an adjustment unit 5006. The adjustment unit 5006 is configured to adjust at least one of the plurality of input units 5002. The adjustment unit 5006 is controlled by a control unit 5008 of the control device 5000. The type of adjustment unit 5006 is not particularly limited. However, it will be appreciated that the adjustment unit may adjust a configuration of at least one of the input units 5002. For example, the adjustment unit 5006 may change a physical location or orientation of at least one of the input units 5002. Alternatively or in addition, the adjustment unit 5006 may change the way in which at least one of the input units 5002 responds to an operation by the user. For example, the adjustment unit may change a stiffness or resistance of the input unit (such as making a button easier or more difficult to depress). Alternatively or in addition, the adjustment unit may change the way in which the input unit responds to an operation by the user.

In the example of FIG. 5, a single adjustment unit 5006 is illustrated. This single adjustment unit 5006 is connected to the plurality of input units 5002. Thus, the adjustment unit 5006 is able to independently adjust any of the plurality of input units 5002. However, in some examples, each of the plurality of input units 5002 may have a corresponding adjustment unit 5006. Thus, in examples, a dedicated adjustment unit may be provided for each input unit 5002. In examples, an adjustment unit may be provided for only a portion of the plurality of input units 5002 of the control device 5000. In these examples, only a portion of the plurality of input units 5002 may be adjustable by the adjustment unit (or units). Therefore, the control device 5000 is not particularly limited to the example configuration illustrated with reference to FIG. 5 of the present disclosure.

Finally, the control device 5000 comprises a control unit 5008. The control unit is configured to control the adjustment unit 5006 to restrict operation of the at least one of the input units 5002 in accordance with adjustment information indicating an availability of each of the plurality of input units for controlling the information processing device. For example, the adjustment information may indicate that one of the plurality of input units 5002 is not mapped to any control operation of the information processing device. Therefore, the control unit 5002 may control the adjustment unit 5006 to restrict operation of that input unit 5002. As an example, the control unit may cause the adjustment unit 5006 to increase a stiffness of the input unit 5002 such that it cannot be operated by the user. As such, a user will then only be able to operate input units of the control device which are available for controlling the information processing device.

In the present disclosure, restricting operation of an input unit 5002 may include preventing the user from operating the input unit (e.g. making the stiffness of the button so high that it cannot be pressed by the user). However, restricting operation of an input unit 5002 may also include making the input unit more difficult to be operated by the user (e.g. increasing the stiffness of the button so that it is more difficult for the user to press the button). Furthermore, restricting operation of an input unit 5002 may also include making said input unit more difficult to operate relative to the other input units of the controller. Therefore, the adjustment unit 5006 may be controlled by the controller 5008 to make the stiffness of one button (for which operation is restricted) higher than the stiffness of another button (for which operation is not restricted).

In examples, the control unit 5008 and the generating unit 5004 of control device 5000 may be implemented as circuitry 5010 of the information processing system 5000. Therefore, while these units are illustrated as separate units of the control device 5000 in the example of FIG. 5, it will be appreciated that the present disclosure is not particularly limited in this regard. The circuitry 5010 may be a microprocessor carrying out computer instructions or may be an Application Specific Integrated Circuit. The computer instructions are stored on storage medium 1004 which maybe a magnetically readable medium, optically readable medium or solid state type circuitry.

Certain features of the information processing system 5000 may also be implemented as part of an information processing device (such as an entertainment system 10 as described with reference to FIG. 2 of the present disclosure). In particular, one or more of the A/V port 90, GPU 30, CPU 20, RAM 40, SSD 50, Optical Drive 70 and/or Data port 60 of the entertainment system 10 may be configured to implement one or more features of the controller 5000 (such as the control unit 5008). Thus, the different units of the controller 5000 may be distributed across a number of different devices. Accordingly, the control device 5000 is not particularly limited to the example configuration illustrated with reference to FIG. 5 of the present disclosure.

Furthermore, in examples, the control device may form part of a system including the control device 5000 and an information processing device (such as the entertainment system 10 as described with reference to FIG. 2 of the present disclosure).

In embodiments of the disclosure, the control device 5000 may be implemented as a handheld control device such as that described with reference to FIG. 3 of the present disclosure. However, in other examples, the control device may be implemented as a control device such as a HMD as described with reference to FIG. 4 of the present disclosure. Further, in other examples, the control device 5000 may be implemented as a different type of control device such as a steering wheel (e.g. for a driving game), a joystick (e.g. for a flying game), a gun (e.g. for a shooting game), a keyboard, a mouse or the like. Therefore, the control device 5000 is not limited to any specific type of control device; the type of the control device 5000 may vary depending upon the situation to which the embodiments of the disclosure are applied.

The control device 5000 of the present disclosure can be dynamically adjusted in accordance with the adjustment information. Thus, certain operations of the input units of the control device can be restricted in order to prevent the user from operating the control device in a way or ways which are not appropriate for a given situation. This can facilitate the use of the control device when training a user for operation of an information processing device. Furthermore, the effects of erroneous operation (such as an increase in user frustration or input delay) can be supressed.

Further details of embodiments of the disclosure will now be provided.

### <Adjustment Information>

As explained with reference to FIG. 5 of the present disclosure, the control device 5000 of the present disclosure is configured to adjust the input units in accordance with adjustment information in order to restrict operability of the input devices. Specifically, the control unit 5008 is configured to control the adjustment unit 5006 to restrict operation of the at least one of the input units 5002 in accordance with adjustment information indicating an availability of each of the plurality of input units for controlling the information processing device.

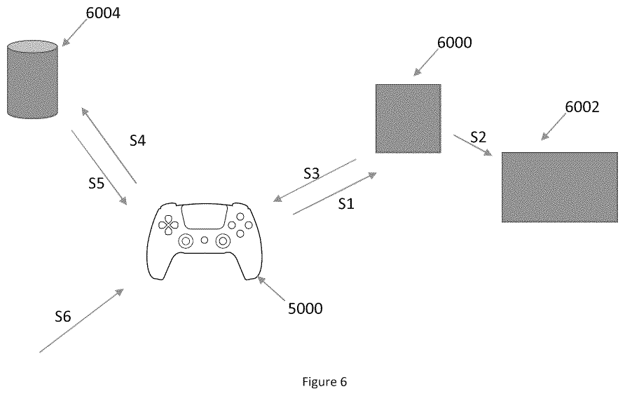

Consider, now, FIG. 6 of the present disclosure. FIG. 6 illustrates an example system in accordance with embodiments of the disclosure.

In this example, a controller 5000 is provided as part of the system. The controller 5000 is implemented as a handheld controller device such as that described with reference to FIG. 3 of the present disclosure. Furthermore, in this example, an information processing device 6000 is provided as part of the system. The information processing device 6000 may be an entertainment system 10 as described with reference to FIG. 2 of the present disclosure.

In this example, a user (not shown) is using the controller 5000 to control the information processing device 6000. Specifically, the user is using the controller 5000 to provide input to software running on the information processing device 6000. More specifically, the user is using the controller 5000 to play a video game being executed by the information processing device 6000.

A display 6002 is provided as part of the system in this example. The information processing device 6000 may generate visual information and display that visual information on the display to the user. For example, the information processing device may generate visual content of the video game and present that visual content to the user on the display. In some examples, the display 6002 may be part of the information processing device 6000.

The system illustrated in FIG. 6 of the present disclosure also include a storage unit 6004. In examples, the storage medium 6004 which maybe a magnetically readable medium, optically readable medium or solid state type circuitry. The storage medium 1004 may be integrated into the information processing device 6000 or the control device 5000. Alternatively, the storage unit 6004 may be separate to the one or both of the information processing device 6000 and the control device 5000 and may be connected thereto using either a wired or wireless connection. In examples, the storage unit 6004 may be located in a server.

The user may provide an input using the control device 5000 in order to control the information processing device. For example, the user may operate an input unit 5002 on the control device 5000 to generate a signal S1 which is transmitted to the information processing device 6000 in order to control a character within the video game.

The information processing device 6000 may then generate display information and transmit this display information S2 to the display device 6002 in order to present the video game to the user.

The controller may comprise a plurality of input units 5002. These may include one or more of a list including: a button, a trigger, a joystick, a joystick button, a touchpad, a touchpad button, a wheel, and/or a pedal. In this example, two joysticks may be provided on the control device (a left-hand joystick and a right-hand joystick). The user can move a player within the video game using the left-hand joystick provided on the control device 5002. However, in this video game, there may be no action assigned or associated with the use of the right-hand joystick. Therefore, if the user was to operate the right-hand joystick, they may become frustrated.

Accordingly, in this example, the control device 5000 is configured to receive adjustment information S3 from the information processing device 6000. As an example, the control unit 5008 of the control device 5000 may be configured to receive this adjustment information from the information processing device 6000.

The adjustment information S3 received from the information processing device 6000 indicates an availability of each of the plurality of input units for controlling the information processing device 6000. Here, in this example, the adjustment information S3 may indicate that the right-hand joystick cannot be used for controlling the video game (having no action associated with its operation). Therefore, the control device 5000 can understand which of the input units can be used to control the video game (and are therefore appropriate operations for the user).

In this specific example, the adjustment information S3 is received from the information processing device 6000. However, the present disclosure is not particularly limited in this regard.

In some examples, the control device may receive a signal from the information processing device. The control device may then be configured to acquire the adjustment information from the storage unit 6004 in accordance with the signal received from the information processing device.

In examples, the signal received from the information received from the information processing device may include a type of the information processing device, a state of the information processing device, and/or a user of the information processing device. For example, the signal from the information processing device 6000 may include identification information indicating the video game currently being played by the user.

Then, upon receiving this signal from the information processing device, the control device may acquire corresponding adjustment information from the storage unit 6004. For example, if the signal indicates that the user is playing a first video game, the control device may acquire adjustment information (indicating an availability of each of the plurality of input units for controlling the information processing device) from the storage unit 6004 corresponding to this first video game. However, if the signal indicates that the user is playing a second video game, the control device may acquire adjustment information corresponding to this second video game from the storage unit 6004. Thus, even if the video games have different controls, the appropriate adjustment information can be easily acquired by the control device such that dynamic adjustment of the input units of the control device can be performed.

As explained, the signal from the information processing device may also include information concerning a type of information processing device. This is because different controls or control operations may be available depending on the type of information processing device. Thus, in some examples, different adjustment information may be acquired by the control device depending on the type of information processing device. Likewise, the adjustment information may also be acquired from the storage unit 6004 in accordance with a signal indicating a user of the information processing device (such as the person who is playing the video game). For example, the control device 5000 may send a request S4 to the storage device to acquire adjustment information corresponding to a signal received from the information processing device. The controller 5000 may then receive this adjustment information S5 from the storage unit 6004.

As an example, different players may have a different mapping between the input units of the controller and the actions of the video game. Therefore, for a first user, the left-hand joystick may control the character within the video game while the right-hand joystick is unassigned. On the other hand, for a second, different, user, the right-hand joystick may control the character within the video game while the left-hand joystick is unassigned. Therefore, different adjustment information may be acquired for different users in this example situation.

In examples, the adjustment information may also depend on the state of the information processing device (such as the state or stage of a video game being played on the information processing device). In these examples, different adjustment information may therefore be acquired depending on the state of the information processing device 6000 in order to dynamically adjust the control device 5000.

In an example, the controller 5000 may also receive a signal S6 from a user. The signal S6 may indicate the adjustment information or may provide certain information which can be used in order to acquire the adjustment information from the storage unit in the same way as described for a signal received from the information processing device 6000.

In examples, the process of receiving or acquiring adjustment information may be repeated each time the adjustment information is updated. This enables the configuration of the control device to be dynamically adapted in real time. For example, the information processing device may update the adjustment information in accordance with a change in state of a game being played on the information processing device; this updated adjustment information may then be provided to the control device and used in order to adjust the input units of the control device. Thus, in examples, the control device may be adjusted in real time in accordance with a state of a game being played on the information processing device.

However, it will be appreciated that the present disclosure is not particularly limited in this regard. In other examples, the adjustment information may be updated at predetermined intervals. Alternatively, the adjustment information may be updated at certain predetermined stages (e.g. at the start of a game being played on the information processing device). Alternatively, the adjustment information may be updated upon detection of a certain event (e.g. when a change of user (or player) has been detected).

As explained with reference to FIG. 6 of the present disclosure, in some examples, the control device 5000 may be provided as part of a system including the information processing device (which can, in examples, be an entertainment system such as that described with reference to FIG. 10 of the present disclosure).

In such an example, the information processing device may be configured to generate the adjustment information and transmit the adjustment information to the control device (e.g. adjustment information S3 as described with reference to FIG. 6 of the present disclosure). This adjustment information transmitted from the information processing system to the control device may then be received by the control device 5000 and used by the control device 5000 in order to adjust the input units.

In such an example, where the adjustment information is generated by the information processing device, the information processing device may be configured to generate the adjustment information in accordance with a state of game being played on the information processing device, a previously operated input unit and/or a number of times a user has operated an input unit for which operation has been restricted. For example, if a user frequently attempts to operate an input unit which does not perform an appropriate function for the given situation, the information processing unit may generate the adjustment information in order to make it progressively more difficult for the user to operate that input unit (e.g. progressively increasing the stiffness of a button on the control device in response to repeated erroneous operations of that button by the user). Therefore, a user can be dissuaded from operation of the input unit and can learn that it is not available for use in the present situation.

In examples, as a user (or player's) level of skill or ability increases, the adjustment information may be adapted by the information processing device in order to reduce the restrictions on operation of the user input units. That is, as the user (or player's) level of skill or ability increases (with a reduced number of attempts to operate an “incorrect” input unit in a given period of time) the extent to which the “incorrect” controls or input units are made unavailable may be reduced. Indeed, eventually, if the skill or ability of the user increases (such that none or very few incorrect user input units are operated on the control device) all user input units may become available. Reducing the level of restriction imposed on the user input units as the skill or ability of the user increases can assist in training the user (with the user input units most likely to be erroneously operated by the user being more heavily restricted). Moreover, reducing the level of restrictions imposed on the user input units in this manner can improve the efficiency of the control device, since additional power consumption (e.g. operation of an actuator associated with an input unit) is reduced when that restriction is no longer required.

Alternatively, as explained, the adjustment information can be updated based on a previously operated input unit. As an example, a certain button (a type of input unit) may not perform an appropriate operation when it is operated independently by a user. However, when that button is operated as part of a combination or sequence by the user, the button may perform an appropriate action (such as being assigned to a certain function in the video game). Therefore, the information processing device may generate the adjustment information and transmit it to the control device in real time such that the control device can be dynamically adjusted in accordance with the operations of the user.

In examples, it has been described that adjustment information may be generated to restrict operation of a user input unit in certain situations; that is, the adjustment information indicates an availability of each of the plurality of input units for controlling the information processing device. For example, it has been described that an input unit may be restricted (as unavailable) when the input unit does not have a corresponding function in the video game currently being played on the information processing device. However, this is not the only situation whereby the adjustment information may be generated to indicate that an input unit is not available and should be restricted. For example, in some situations, the use of the input unit may be restricted when operation of the input unit by the user would be disadvantageous. Taking the example of a video game, use of a certain input unit of the controller may be restricted if its operation by the user would cause the user to lose the video game (or otherwise suffer an undesirable consequence in the video game). In this situation, the restriction of the input unit (in accordance with the adjustment information which has been generated by the information processing device) may prevent the user from inadvertently performing an erroneous operation (through operation of a restricted input unit) and may therefore suppress undesirable outcomes in the video game for the user.

The information processing device may further generate the adjustment information in accordance with a setting such as a difficulty level of the video game. For example, on a beginner setting, the adjustment information may be generated in order to restrict operations of input units of the control device which would be disadvantageous for the user. However, on a harder difficulty setting (such as an expert setting) the restrictions imposed by the adjustment information may be reduced.

In this way, the controller 5000 can receive or acquire adjustment information which can be used in order to dynamically adjust the input units of the control device 5000.

### <Adjustment>

As explained with reference to FIG. 5 of the present disclosure, the control device 5000 further comprises an adjustment unit 5006 configured to adjust at least one of the plurality of input units 5002 and a control unit configured to control the adjustment unit to restrict operation of the at least one of the input units in accordance with adjustment information indicating an availability of each of the plurality of input units 5002 for controlling the information processing device.

The type of adjustment unit 5006 is not particularly limited in accordance with embodiments of the disclosure. Generally, any suitable adjustment unit 5006 may be used in order to restrict operation of the at least one of the input units under control of the control unit 5008. As explained, restricting the input unit may include dynamically adjusting the input unit in order that it cannot be operated by the user. Alternatively, restricting the input unit may include dynamically adjusting the input unit in order that it is more difficult for the user to operate the input unit.

Consider, again, the example of FIG. 5 of the present disclosure. In this example, the user is playing a video game on the information processing device 6000. The user controls the information processing device (and thus controls the video game) by operating one or more input devices on the control device. In this example, the left-hand joystick can be used in order to control the movement of a character within the video game. However, in this example, the right-hand joystick is not assigned to any action within the video game. Therefore, use of the right-hand joystick is not appropriate. Any operation of the right-hand joystick by the user is an erroneous operation which will increase the frustration of the user. Furthermore, if the user continues to attempt to control their character within the video game by operating the right-hand joystick, they will inadvertently delay the time at which the appropriate control signal is provided (using the left-hand joystick).

Said erroneous operation of the control device may be more likely to occur when the user is a novice or an inexperienced user. For example, the user may be playing a particular video game for the first time on the information processing device. As such, the user may not yet have learned the appropriate control operations which can be performed (using the input devices) for that video game using the controller.

Accordingly, in this example, the control device may receive (or acquire) adjustment information in the manner described with reference to FIG. 6 of the present disclosure. The adjustment information may indicate an availability of each of the plurality of input units for controlling the information processing device. More specifically, the adjustment information may indicate that the left-hand joystick is available for operation while the right-hand joystick is not available for operation (and that use of the right-hand joystick should be restricted).

In some examples, the adjustment unit may comprises a resistive feedback unit. Said unit may increase the resistance which is felt when an input unit is operated by the user. For example, increasing the resistance will make the input unit more difficult for the user to operate while decreasing the resistance will make it easier for the user to operate the input unit. In the example of a button as an input unit, increasing the resistance using the resistive feedback unit may make the button harder to press (as the user will feel more resistance against their operation) while decreasing the resistance may make it easier to press the button. In the example of a joystick as an input device, increasing the resistance using the resistive feedback unit may make it more difficult to move the joystick (as the user will feel more resistance against their operation) while decreasing the resistance may make it easier to move the joystick.

Thus, in this specific example, the control unit may increase the resistive feedback for the right-hand joystick in order that it becomes more difficult for the user to operate the right-hand joystick. In contrast, the resistive feedback for the left-hand joystick may be made low. As such, if the user attempts to use the right-hand joystick, they will immediately realise that it is very difficult to operate. They will then understand that use of the right-hand joystick is not appropriate in the present situation. The user will then the use the left-hand joystick in order to control the movement of the character in the video game.

Accordingly, in embodiments, the control unit is configured to control the resistive feedback unit to restrict operation of the at least one of the input units in accordance with the adjustment information.

In this way, it becomes easier for the user to learn and understand which input unit of the control device can be used in the present situation. Therefore, erroneous operation is suppressed and frustration of the user is reduced.

In some examples, the adjustment unit may comprise an actuator the control unit may be configured to control the actuator to restrict operation of the at least one of the input units in accordance with the adjustment information.

Similar to the resistive feedback unit, the actuator may be used (by the control unit) to provide a force against the operation of the input unit by the user (such as making a button harder to operate for the user). In this way, a resistive force can be provided (by the actuator) against the operation of the input unit such that the user will immediately realise that the operation is not available if they try to operate the input unit. However, in other examples, the actuator may physically move the input unit in order to make the input unit more difficult for the user to operate (and thus restrict the operation of that input unit).

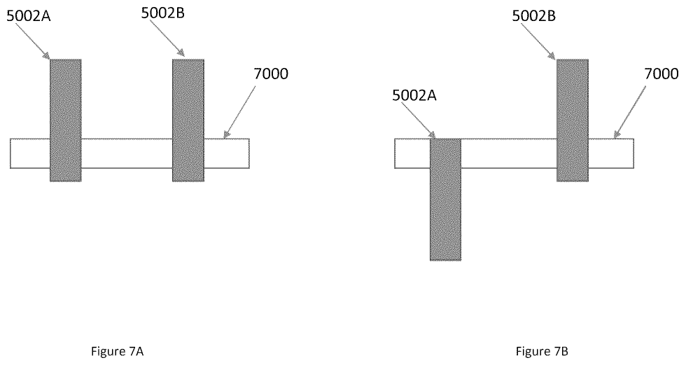

Consider, now, FIGS. 7A and 7B of the present disclosure. These Figures illustrate an example adjustment of an input unit in accordance with embodiments of the disclosure.

FIG. 7A shows a portion of a control device 5000. The portion of the control device 5000 shown in FIG. 7A comprises two input units 5002A and 5002B. These input units 5002A and 5002B are buttons which can be operated by the user. However, while this example is described with buttons as the input units, it will be appreciated that more generally embodiments of the disclosure can be applied to the use of other types of input units.

In FIG. 7A of the present disclosure, a casing of the control device 5000 is also shown. The casing is the outer cover or shell of the controller. Indeed, the casing is the portion of the controller which is held by the user in the example of a handheld controller as the control device 5000.

In FIG. 7A, the user may press the input unit 5002A in order to generate an input signal to perform a certain action or control of the information processing device. Alternatively or in addition, the user may press the input unit 5002B in order to generate a second input signal to perform a second certain action or control of the information processing device.

However, at a certain time (e.g. when the user starts to play a certain video game on the information device) the control device may receive or acquire adjustment information concerning availability of the input units.

In this example, the adjustment information may indicate that the input unit 5002A should not be available (and does not provide an appropriate input command). Accordingly, on the basis of the adjustment information, the control unit 5008 may restrict operation of the first input unit 5002A.

In this example, the adjustment unit comprises an actuator. Therefore, the control unit may control the actuator to physically move the input unit 5002A in order to make the input unit more difficult for the user to operate.

FIG. 7B of the present disclosure illustrates the configuration of the control device once the input unit 5002A has been moved by the actuator. That is, FIG. 7B of the present disclosure illustrates the same portion of the control device 5000 as shown in FIG. 7A of the present disclosure. However, FIG. 7B of the present disclosure illustrates this portion of the control device 5000 after adjustment has been performed.

Specifically, in this example, the adjustment unit has-under control of the control unit in accordance with the adjustment information-physically moved the input unit 5002A in order that its use has been restricted. In this example, the actuator has retracted the input unit 5002 within the casing 7000 of the control device 5000. Therefore, a user is not able to operate the input unit 5002A and erroneous operation of the device can be reduced.

In this example, the user input unit 5002B remains in its original position and is available for use by the user.

The example of FIGS. 7A and 7B has been described with reference to a situation whereby the input unit 5002A is fully retracted within the casing of the control device. However, the present disclosure is not particularly limited in this regard. In examples, the user input unit for which use should be restricted may be only partially retracted within the casing of the control device. In this situation, the user input unit 5002A may be more difficult to operate than user input unit 5002B and the user will immediately realise that operation of the user input unit 5002A should be avoided. This can reduce erroneous operation of the device.

Thus, in examples, the control unit may be configured to control the actuator by at least partially retracting the at least one of the input units within a casing of the control device to prevent operation by a user.

In some examples, the adjustment unit 5006 may comprises a haptic generator and the control unit 5008 of the control device may be configured to control the haptic generator to restrict operation of the at least one of the input units in accordance with the adjustment information.

For example, the haptic generator may provide haptic feedback to the user when the user attempts to operate an input unit for which the use has been restricted. As an example, the control device may provide a haptic feedback such as shaking of the control device when the user attempts to operate an input device for which the operation has been restricted. As such, the user will immediately realise that operation of the user input unit 5002A should be avoided. This can reduce erroneous operation of the device.

In some examples, the haptic feedback may be provided to the user through the input unit which has been restricted. For example, if the user attempts to operate a restricted joystick on the control device, the haptic feedback may be provided to the user through vibration of that joystick. Alternatively, haptic feedback may be provided to the user through a haptic generator which is not directly linked to the input unit.

In some examples, the adjustment unit 5006 may be configured to adjust a sensitivity of the at least one of the plurality of input units and the control unit 5008 may be configured to control the adjustment unit to restrict operation of the at least one of the input units by reducing the sensitivity of the at least one of the plurality of input units.

As an example, the sensitivity of each button may be restricted. For instance, if a button (a type of input unit) has 32 levels of “press”, the output of the button may be ignored for every level except the final level of press. In this way, the user will notice that this button does not perform any action unless it is pressed very hard. In addition, buttons (or other input units) which are appropriate for the present situation may generate an input signal even for the first (lightest) level of press. The user may thus notice a distinction in the perceived sensitivity of the buttons and will quickly learn that the restricted button should not be used. Accordingly, erroneous operation can be suppressed.

However, in some examples, the adjustment information may be generated in order to restrict operations of an input unit which would cause an undesirable outcome if operated by the user. In these cases, it may be advantageous if the user can override the restrictions imposed on the input units. For example, a user may, in some situations, need to perform a certain input (with a restricted input device) even if the outcome is generally considered to be disadvantageous. In these situations, the user may therefore forcefully press a button (or other type of input unit) to provide an input above a threshold value (e.g. the highest level of sensitivity as described above) to override the restriction on use of the input unit. However, accidental inputs (with a force below said sensitivity threshold) may still be restricted and will not cause the generating unit to generate an input signal.

Therefore, adaption of the sensitivity of the input units of the control device can be performed in order to reduce erroneous operations of the device. Of course, it will be appreciated that the present disclosure is not specifically limited to the example of 32 levels of sensitivity and may, more generally be applied. Indeed, the sensitivity of the input unit may not necessarily correspond to discrete levels of sensitivity at all. Instead, there may be a continuum of sensitivity levels of the input units of the control device.

### <Feedback>

As explained above, the control unit may control the adjustment unit to restrict the ability of the user to operate one or more of the input devices of the controller. This reduces the likelihood of the user performing an erroneous operation and can make it easier for the user to understand which of the input units of the controller are available in a given situation.

However, in some embodiments of the disclosure, additional feedback may be provided to the user (in addition to restriction of operability of the input unit) in order to notify the user that the input unit is not available for use. This can further improve the training provided to the user such that the user can more quickly learn and understand that the input unit is not available for operation in the present situation.

The type of additional feedback which is provided to the user is not particularly limited in accordance with embodiments of the disclosure. However, in examples, the additional feedback may comprise visual feedback or audio feedback.

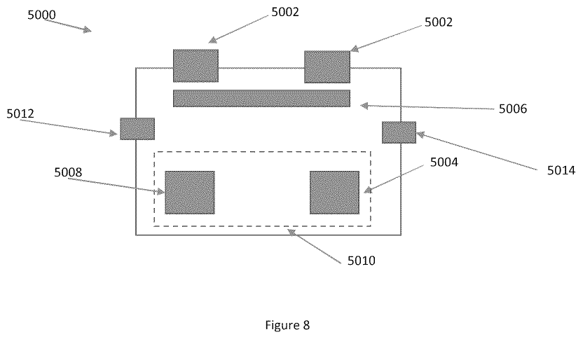

Consider, now, FIG. 8 of the present disclosure. FIG. 8 illustrates an example control device in accordance with embodiments of the disclosure.

The example control device 5000 illustrated in FIG. 8 of the present disclosure comprises a plurality of user input units 5002, a generating unit 5004, an adjustment unit 5006 and a control unit 5010. The generating unit 5004 and the control unit 5008 may comprise circuitry 5010 of the control device 5000.

The details of the plurality of input units 5002, the generating unit 5004, the adjustment unit 5006 and the control unit 5008 of the control device 5000 are the same as have been described with reference to FIGS. 5, 6 and 7 of the present disclosure. As such, further discussion of the features of these units will not be provided for brevity of the disclosure.

However, in addition to the configuration illustrated in FIG. 5 of the present disclosure, the control device of FIG. 8 of the present disclosure further comprises an audio generation unit 5012 and a light source 5014. Each of the audio generation unit 5012 and the light source 5014 can be used to provide additional feedback to the user in the event of an (attempted) operation of an input unit for which operation has been restricted.

The audio generation unit 5012 may be implemented as any suitable device which can generate audio (sound) which can be heard by the user. For example, the audio generation unit 5012 may be a speaker.

The control unit 5008 of the control device may be configured to control the audio generation unit 5012 when a user operates (or attempts to operate) an input unit for which operation has been restricted. For example, the control unit may restrict operation of a button on the control device by making the button more difficult for the user to press (by increasing the stiffness of the button, for example). However, if the user overcomes this resistance and presses the button, then the generation unit 5004 will generate an input signal (indicated that the button has been pressed by the user). In this case, the control unit 5008 may then identify that a restricted button has been pressed by the user. Accordingly, the control unit 5008 may control the audio generation unit 5012 in order to generate audio which informs the user that they have operated a restricted button. This can be any type of audio. However, in examples, this may include a warning sound or a warning message (such as “button not available”). Therefore, even if the user operates a button (or other input unit for which operation has been restricted, the user may immediately realise their error and avoid further erroneous use of the button.

Alternatively, or in addition, the control unit 5008 may be configured to control the light source unit 5014 to generate a visual indication of the availability of the at least one input unit (or input units) for controlling the information processing device.

In examples, the light source unit 5002 may be a light emitting diode. However, the present disclosure is not particularly limited in this regard and any type of light source can be used in accordance with embodiments of the disclosure. In some examples, there may be a single light source (illuminated when an erroneous operation is made, for example). In other examples, there may be a plurality of light sources. Indeed, in some examples, each of the plurality of input units may have a corresponding light source. The corresponding light source for an input unit may include a backlight, for example.

In examples, the control unit may control the plurality of light sources to generate a visual indication of the availability of the at least one input unit (or input units) for controlling the information processing device. In examples, the light source may be configured to produce different colours of light. For example, a first colour (such as red) may be used to indicate that the user input unit is not available while a second colour (such as green) may be used to indicate that the user input unit is available.

In this way, the user of the control device receives a visual indication of the availability of the user input units; therefore a user may be dissuaded from attempting to use an input unit which is not available and/or may be visually informed that they have attempted to operate a user input unit for which operations have been restricted. This may further reduce erroneous operation by the user.

While the additional feedback has been described as being provided through the control device 5000, it will be appreciated that the present disclosure is not particularly limited in this regard. In some examples, additional feedback (such as an audio or visual warning message) may be provided by an external device such as the information processing device (e.g. using an external display device).

Therefore, in embodiments the control device 5008 and/or the generating unit 5004 may be configured to transmit a warning signal to the information processing device when a user operates an input unit for which operation has been restricted, the warning signal being configured to cause the information processing device to display a warning to the user. The warning may include a warning message (such as, “restricted button pressed”) or the like. In this way, the user can easily identify that an incorrect user input unit of the control device has been operated. Further erroneous operation of the control device can therefore be suppressed.

Thus, in embodiments of the disclosure, restriction of operation of the input units may be accompanied by appropriate visual and/or audio feedback (either via the control device 5000 or an associated display device).

### <Method>

Hence, more generally, a method of a control device for controlling an information processing device is provided in accordance with embodiments of the disclosure. The control device may be a control device as described in accordance with embodiments of the disclosure. In particular, the control device may comprise a plurality of input units configured to be operated by a user; and a generating unit configured to generate an input signal when at least one of the plurality of input units is operated by the user; and an adjustment unit configured to adjust at least one of the plurality of input units.

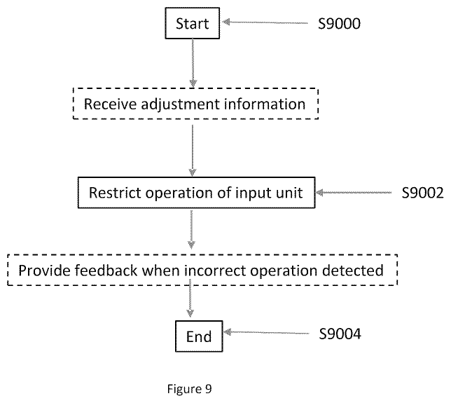

An example method in accordance with embodiments of the disclosure is illustrated in FIG. 9 of the present disclosure. The method starts at step S9000. The method then proceeds to step S9002. In step S9002, the method comprises adjusting at least one of the plurality of input units to restrict operation of the at least one of the input units in accordance with adjustment information indicating an availability of each of the plurality of input units for controlling the information processing device. The method then proceeds to, and ends with, step S9004.

The present disclosure is not particularly limited to the steps of the method as illustrated in FIG. 9 of the present disclosure. Instead, FIG. 9 provides an example of the information processing method of the present disclosure.

In some examples, a number of additional method steps may be performed. As an example, an additional optional step of receiving adjustment information from the information processing device may form part of the method. This additional, optional, step is shown with dashed lines in FIG. 9 of the present disclosure. This additional optional step may enable the control device to be reconfigured by the information processing device. However, alternatively, the adjustment information may be pre-stored within the control device or acquired by the control device in response to a signal from the information processing device or a signal from a user, for example.

Furthermore, in some example, an additional, optional, step of providing feedback to the user may be performed. This additional, optional, step is shown with dashed lines in FIG. 9 of the present disclosure. Specifically, the method may further comprise controlling an additional unit (such as the light source unit) in order to provide feedback (such as a visual indication) to the user to indicate that they have operated an incorrect input unit of the control device.

In addition, it will be appreciated that the process of adjusting the at least one input unit of the plurality of input units of the control device may be repeated each time the adjustment information is updated (e.g. each time the adjustment information is received from the information processing device). This enables the configuration of the control device to be dynamically adapted in real time depending on the adjustment information which has been received. For example, the information processing device may update the adjustment information in accordance with a change in state of a game being played on the information processing device; this updated adjustment information may then be provided to the control device and used in order to adjust the input unit of the control device. Thus, in examples, the control device may be adjusted in real time in accordance with a state of a game being played on the information processing device.

However, it will be appreciated that the present disclosure is not particularly limited in this regard. In other examples, the adjustment information may be updated at predetermined intervals. Alternatively, the adjustment information may be updated at certain predetermined stages (e.g. at the start of a game being played on the information processing device). Alternatively, the adjustment information may be updated upon detection of a certain event (e.g. when a change of user (or player) has been detected).

Thus, in accordance with embodiments of the disclosure, a method of a control device for controlling an information processing device is provided in accordance with embodiments of the disclosure.

### <Computer Program>

Furthermore, it will be appreciated that the above methods may be carried out on conventional hardware (such as that described previously herein) suitably adapted as applicable by software instruction or by the inclusion or substitution of dedicated hardware. Thus, the required adaptation to existing parts of a conventional equivalent device may be implemented in the form of a computer program product comprising processor implementable instructions stored on a non-transitory machine-readable medium such as a floppy disk, optical disk, hard disk, PROM, RAM, flash memory or any combination of these or other storage media, or realized in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

### CLAUSES

In addition, embodiments of the present disclosure may be arranged in accordance with the following numbered clauses:
1. A control device for controlling an information processing device, the control device comprising: a plurality of input units configured to be operated by a user; a generating unit configured to generate an input signal when at least one of the plurality of input units is operated by the user; an adjustment unit configured to adjust at least one of the plurality of input units; and a control unit configured to control the adjustment unit to restrict operation of the at least one of the input units in accordance with adjustment information indicating an availability of each of the plurality of input units for controlling the information processing device.
2. The control device according to clause 1, wherein the plurality of input units include one or more of a list including: a button, a trigger, a joystick, a touchpad, a touchpad button, a wheel, and/or a pedal.
3. The control device according to clause 1 or 2, where the generating unit is configured to transmit the input signal to the information processing device.
4. The control device according to any of clauses 1 to 3, wherein the control unit is configured to receive the adjustment information from the information processing device.
5. The control device according any preceding clause, wherein the control unit is configured to acquire the adjustment information from a storage unit in accordance with a signal received from the information processing device.
6. The control device according to clause 5, wherein the signal received from the information received from the information processing device includes a type of the information processing device, a state of the information processing device, and/or a user of the information processing device.
7. The control device according to any preceding clause, wherein the adjustment unit comprises a resistive feedback unit and wherein the control unit is configured to control the resistive feedback unit to restrict operation of the at least one of the input units in accordance with the adjustment information.
8. The control device according to any preceding clause, wherein the adjustment unit comprises an actuator and wherein the control unit is configured to control the actuator to restrict operation of the at least one of the input units in accordance with the adjustment information.
9. The control device according to clause 8, wherein the control of the actuator includes at least partially retracting the at least one of the input units within a casing of the control device to prevent operation by a user.
10. The control device according to any preceding clause, wherein the adjustment unit comprises a haptic generator and wherein the control unit is configured to control the haptic generator to restrict operation of the at least one of the input units in accordance with the adjustment information.
11. The control device according to clause 10, wherein the control unit is configured to control the haptic generator to provide haptic feedback to the user when a user operates an input unit for which operation has been restricted.
12. The control device according to clause 11, wherein the haptic feedback is provided to the user by the haptic generator through the input unit.
13. The control device according to any preceding clause, wherein the adjustment unit is configured to adjust a sensitivity of the at least one of the plurality of input units and wherein the control unit is configured to control the adjustment unit to restrict operation of the at least one of the input units by reducing the sensitivity of the at least one of the plurality of input units.
14. The control device according to clause 13, wherein the control unit is configured to reduce the sensitivity of the at least one of the plurality of input units such that operation of the input unit by the user below a threshold value will not cause the generating unit to generate an input signal.
15. The control device according to any preceding clause, wherein the generating unit is further configured to transmit a warning signal to the information processing device when a user operates an input unit for which operation has been restricted, the warning signal being configured to cause the information processing device to control a display device to display a warning to the user.
16. The control device according to any preceding clause, further comprising an audio generation unit; wherein control unit is further configured to control the audio generation unit when a user operates an input unit for which operation has been restricted.
17. The control device according to any preceding clause, further comprising a light source unit coupled with at least one of the plurality of input units; wherein the control unit is further configured to control the light source unit in accordance with an availability of the at least one of the plurality of input units for controlling the information processing device.
18. A system for controlling an information processing device: an information processing device; and a control device for controlling the information processing device, the control device comprising: a plurality of input units configured to be operated by a user; a generating unit configured to generate an input signal when at least one of the plurality of input units is operated by the user; an adjustment unit configured to adjust at least one of the plurality of input units; and a control unit configured to control the adjustment unit to restrict operation of the at least one of the input units in accordance with adjustment information indicating an availability of each of the plurality of input units for controlling the information processing device.
19. The system according to clause 18, wherein the information processing device is configured to generate the adjustment information and transmit the adjustment information to the control device; and wherein the control device is configured to receive the adjustment information from the information processing device.
20. The system according to clause 19, wherein the information processing device is configured to generate the adjustment information in accordance with a state of game being played on the information processing device, a previously operated input unit and/or a number of times a user has operated an input unit for which operation has been restricted.
21. The system according to any of clauses 18 to 20, wherein the information processing device is configured to update the adjustment information at predetermined intervals of time, in accordance with a detected event, and/or at predetermined stages of a game being played on the information processing device.
22. A method of a control device for controlling an information processing device, the control device comprising: a plurality of input units configured to be operated by a user; and a generating unit configured to generate an input signal when at least one of the plurality of input units is operated by the user; and an adjustment unit configured to adjust at least one of the plurality of input units; wherein the method comprises: adjusting at least one of the plurality of input units to restrict operation of the at least one of the input units in accordance with adjustment information indicating an availability of each of the plurality of input units for controlling the information processing device.
23. A computer program comprising instructions which, when operated by a computer, cause the computer to implement a method according to clause 22.
24. A non-transient computer readable storage medium storing the computer program according to clause 23.

While some embodiments of the disclosure have been described with reference to an example situation of using a controller to play a video game, the present disclosure is not particularly limited in this regard. That is, embodiments of the present disclosure may be applied to a number of different situations and are not limited to the example of a video game. For example, embodiments of the disclosure may be applied to a situation where an information processing device is running software other than a video game (including web browsing software, image editing software, video editing software, communication software, word processing software, video playback or video editing software, banking software or the like). Alternatively, embodiments of the disclosure may be applied to a situation where a controller is used to control an information processing device such as a robotic device. This may include an articulated robotic device, a medical robotic device, a surgical robotic device, an industrial robotic device, a robotic arm, a humanoid robotic device or the like.

Indeed, more generally, embodiments of the disclosure may be applied to any situation where it is desired to restrict a user from operating one or more input units of a control device.

It will be appreciated that numerous modifications and variations of the present disclosure are possible in light of the above teachings. It is therefore to be understood that within the scope of the appended claims, the disclosure may be practiced otherwise than as specifically described herein.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognize that various features of the described embodiments may be combined in any manner suitable to implement the technique.

1. A control device for controlling an information processing device, the control device comprising:
a plurality of input units configured to be operated by a user;
a generating unit configured to generate an input signal when at least one of the plurality of input units is operated by the user;
an adjustment unit configured to adjust at least one of the plurality of input units; and
a control unit configured to control the adjustment unit to restrict operation of the at least one of the input units in accordance with adjustment information indicating an availability of each of the plurality of input units for controlling the information processing device.

2. The control device according to claim 1, wherein the plurality of input units include one or more of a list including: a button, a trigger, a joystick, a joystick button, a touchpad, a touchpad button, a wheel, and/or a pedal.

3. The control device according to claim 1, where the generating unit is configured to transmit the input signal to the information processing device.

4. The control device according to claim 1, wherein the control unit is configured to receive the adjustment information from the information processing device.

5. The control device according claim 1, wherein the control unit is configured to acquire the adjustment information from a storage unit in accordance with a signal received from the information processing device.

6. The control device according to claim 5, wherein the signal received from the information received from the information processing device includes a type of the information processing device, a state of the information processing device, and/or a user of the information processing device.

7. The control device according to claim 1, wherein the adjustment unit comprises a resistive feedback unit and wherein the control unit is configured to control the resistive feedback unit to restrict operation of the at least one of the input units in accordance with the adjustment information.

8. The control device according to claim 1, wherein the adjustment unit comprises an actuator and wherein the control unit is configured to control the actuator to restrict operation of the at least one of the input units in accordance with the adjustment information.

9. The control device according to claim 8, wherein the control of the actuator includes at least partially retracting the at least one of the input units within a casing of the control device to prevent operation by a user.

10. The control device according to claim 1, wherein the adjustment unit comprises a haptic generator and wherein the control unit is configured to control the haptic generator to restrict operation of the at least one of the input units in accordance with the adjustment information.

11. The control device according to claim 10, wherein the control unit is configured to control the haptic generator to provide haptic feedback to the user when a user operates an input unit for which operation has been restricted.

12. The control device according to claim 11, wherein the haptic feedback is provided to the user by the haptic generator through the input unit.

13. The control device according to claim 1, wherein the adjustment unit is configured to adjust a sensitivity of the at least one of the plurality of input units and wherein the control unit is configured to control the adjustment unit to restrict operation of the at least one of the input units by reducing the sensitivity of the at least one of the plurality of input units.

14. The control device according to claim 13, wherein the control unit is configured to reduce the sensitivity of the at least one of the plurality of input units such that operation of the input unit by the user below a threshold value will not cause the generating unit to generate an input signal.

15. The control device according to claim 1, wherein the generating unit is further configured to transmit a warning signal to the information processing device when a user operates an input unit for which operation has been restricted, the warning signal being configured to cause the information processing device to control a display device to display a warning to the user.

16. The control device according to claim 1, further comprising an audio generation unit; wherein control unit is further configured to control the audio generation unit when a user operates an input unit for which operation has been restricted.

17. The control device according to claim 1, further comprising a light source unit coupled with at least one of the plurality of input units; wherein the control unit is further configured to control the light source unit in accordance with an availability of the at least one of the plurality of input units for controlling the information processing device.

18. A system for controlling an information processing device:
an information processing device; and
a control device for controlling the information processing device, the control device comprising:
a plurality of input units configured to be operated by a user;
a generating unit configured to generate an input signal when at least one of the plurality of input units is operated by the user;
an adjustment unit configured to adjust at least one of the plurality of input units; and
a control unit configured to control the adjustment unit to restrict operation of the at least one of the input units in accordance with adjustment information indicating an availability of each of the plurality of input units for controlling the information processing device.

19. A method of a control device for controlling an information processing device, the control device comprising: a plurality of input units configured to be operated by a user; and a generating unit configured to generate an input signal when at least one of the plurality of input units is operated by the user; and an adjustment unit configured to adjust at least one of the plurality of input units; wherein the method comprises:
adjusting at least one of the plurality of input units to restrict operation of the at least one of the input units in accordance with adjustment information indicating an availability of each of the plurality of input units for controlling the information processing device.

20. A non-transitory computer-readable storage medium storing a computer program comprising instructions which, when executed by a computer, cause the computer to perform a method of a control device for controlling an information processing device, the control device comprising: a plurality of input units configured to be operated by a user; and a generating unit configured to generate an input signal when at least one of the plurality of input units is operated by the user; and an adjustment unit configured to adjust at least one of the plurality of input units; wherein the method comprises:
adjusting at least one of the plurality of input units to restrict operation of the at least one of the input units in accordance with adjustment information indicating an availability of each of the plurality of input units for controlling the information processing device.
